(19) United States
(12) Patent Application Publication
(10) Pub. No.: US 2008/0129676 A1
(43) Pub. Date: Jun. 5, 2008

(54) Liquid crystal display device and method of driving the same

(76) Inventors: Binn Kim, Seoul (KR); Hae Yeol Kim, Seongnam Si (KR); Su Hwan Moon, Gumi-si (KR); Seung Chan Choi, Gyeongsan-si (KR)

Correspondence Address: MCKENNA LONG & ALDRIDGE LLP, 1900 K STREET, NW, WASHINGTON, DC, 20006, US

(21) Appl. No.: 11/984,823

(22) Filed: Nov. 21, 2007

(30) Foreign Application Priority Data
Nov. 30, 2006 (KR) P2006-120193

(51) Int. Cl. G09G 3/36

(52) U.S. Cl. 345/99; 345/88

(57) ABSTRACT

A liquid crystal display device and a method of driving the same is disclosed that can decrease the number of data lines used therein, and can improve the picture quality. The liquid crystal display device includes a display area including a plurality of pixel cells formed in respective regions defined by a plurality of gate and data lines, the pixel cells along a data-line direction provided with at least three colors repetitively arranged by turns, and the pixel cells along a gate-line direction provided with the same color, wherein polarity of video signal is inverted every 2N pixel cells (‘N’ is an integer) along the data-line direction.

This application claims the benefit of Korean Patent Application No. 2006-120193 filed on Nov. 30, 2006, which is hereby incorporated by reference as if fully set forth herein.

### BACKGROUND OF THE INVENTION

1. Field of the Invention

The present invention relates to a liquid crystal display device, and more particularly, to a liquid crystal display device using a reduced number of data lines and a method of driving the same.

2. Discussion of the Related Art

Recently, various flat panel display devices have been developed to overcome disadvantageous large weight and size characteristic of Cathode Ray Tube (CRT) based display devices. Examples of the flat panel display devices include a liquid crystal display (LCD) device, a field emission display (FED), a plasma display panel (PDP), and a light-emitting display device. Among the various flat display devices, the liquid crystal display device can display picture images by controlling light transmittance with an electric field applied thereto.

FIG. 1 is a schematic diagram illustrating a liquid crystal display device according to the related art. As shown in FIG. 1, the liquid crystal display device according to the related art includes a plurality of pixel cells which are formed in respective regions defined by the crossings of plurality of gate lines GL with a plurality of data lines DL.

Along a gate-line GL direction, the pixel cells of red (R), green (G) and blue (B) colors are repetitively arranged by turns. This arrangement of pixel cells is referred to as a vertical-stripe type pixel structure. In this case, the red (R), green (G) and blue (B) pixel cells constitute one unit pixel to display one color image.

Each of the pixel cells includes a thin film transistor T connected to the data line DL and the gate line GL, and a pixel P connected to the thin film transistor T. The thin film transistor T is turned-on by a gate signal supplied to the gate line GL, whereby a video signal of the data line DL is supplied to the pixel P. The pixel P controls the light transmittance according to the video signal supplied through the thin film transistor T.

In the liquid crystal display device according to the related art, the gate signal is supplied to the gate lines GL in sequence, and the video signal is supplied to the data line DL, so that the thin film transistor T is turned-on by the gate signal and the video signal supplied to the data line DL is supplied to the pixel P. Accordingly, each of the pixel cells controls the light transmittance through the pixel cell accordingly the video signal supplied to the pixel P, thereby displaying the color image corresponding to the video signal.

However, the liquid crystal display device according to the related art has the following disadvantage.

The liquid crystal display device according to the related art is provided with the vertical-stripe type pixel structure. This pixel structure inevitably uses three data lines to drive each unit pixel. As a result, output channels of data driver to supply the video signal to the data line are large in number resulting in an increase in the fabrication cost of device.

### SUMMARY OF THE INVENTION

Accordingly, the present invention is directed to a liquid crystal display device and a method of driving the same that substantially obviates one or more problems due to limitations and disadvantages of the related art.

An advantage of the present invention is to provide a liquid crystal display device which can decrease the number of data lines, and a method of driving the same.

Another advantage of the present invention is to provide a liquid crystal display device which can improve the picture quality and lower the power consumption, and a method of driving the same.

Additional advantages and features of the invention will be set forth in part in the description which follows and in part will become apparent to those having ordinary skill in the art upon examination of the following or may be learned from practice of the invention. These and other advantages of the invention will be realized and attained by the structure particularly pointed out in the written description and claims hereof as well as the appended drawings.

To achieve these and other advantages and in accordance with the purpose of the invention, as embodied and broadly described herein, a liquid crystal display device includes a display area including a plurality of pixel cells formed in respective regions defined by a plurality of gate and data lines, the pixel cells along a data-line direction provided with at least three colors repetitively arranged by turns, and the pixel cells along a gate-line direction provided with the same color, wherein polarity of video signal is inverted every 2N pixel cells (‘N’ is an integer) along the data-line direction.

At this time, the adjacent pixel cells of at least three colors along the data-line direction constitute one unit pixel.

In another aspect of the present invention, a liquid crystal display device comprises a display area including a plurality of pixel cells formed in respective regions defined by a plurality of gate and data lines, the pixel cells along a data-line direction provided with at least three colors repetitively arranged by turns, and the pixel cells along a gate-line direction provided with the same color, wherein the adjacent pixel cells of at least three colors along the data-line direction constitute one unit pixel, and one unit pixel is different from another unit pixel being adjacent along the data-line direction in its pixel cell where a transition of video signal occurs.

In addition, the liquid crystal display device includes a gate driver to drive the gate lines in sequence; a data driver to supply video signals to the data lines; and a timing controller to align source data supplied from the external as data signals, to supply the data signals to the data driver, and to control the gate and data drivers.

At this time, the timing controller time-divides one horizontal period into first, second, and third sub-periods; aligns the source data as the data signals for the first, second, and third sub-periods; supplies the aligned data signals to the data driver; and generates a control signal including a polarity control signal to invert the polarity of video signal every 2N pixel cells along the data-line direction.

Also, the data driver converts the data signal into the video signal; inverts the polarity of video signal according to the polarity control signal; and supplies the video signal with the inverted polarity to the data line.

The data driver supplies the video signals of the different polarities to the adjacent pixel cells along the gate-line direction.

In another aspect of the present invention, a driving method of liquid crystal display device comprises supplying video signals with the different polarities to pixel cells by inverting the polarity of video signal every 2N pixel cells (‘N’ is an integer) along a data-line direction in a display area including a plurality of pixel cells formed in respective regions defined by a plurality of gate and data lines, the pixel cells along the data-line direction provided with at least three colors repetitively arranged by turns, and the pixel cells along a gate-line direction provided with the same color.

At this time, the adjacent pixel cells of at least three colors along the data-line direction constitute one unit pixel.

In another aspect of the present invention, a driving method of liquid crystal display device provided with a display area including a plurality of pixel cells formed in respective regions defined by a plurality of gate and data lines, the pixel cells along a data-line direction provided with at least three colors repetitively arranged by turns, and the pixel cells along a gate-line direction provided with the same color, comprises supplying gate signals to the gate lines in sequence; and supplying video signals to the data lines in synchronization with the gate signal, wherein the adjacent pixel cells of at least three colors along the data-line direction constitute one unit pixel, and one unit pixel is different from another unit pixel being adjacent along the data-line direction in its pixel cell where a transition of video signal occurs.

In addition, the driving method includes time-dividing one horizontal period into first, second, and third sub-periods, and aligning source data supplied from the external as data signals for the first, second, and third sub-periods; and supplying the aligned data signals to the data driver, and generating a control signal including a polarity control signal to invert the polarity of video signal every 2N pixel cells along the data-line direction.

Also, supplying the video signal to the data lines comprises converting the data signal aligned for the respective sub-periods into the video signal; inverting the polarity of video signal according to the polarity control signal; and supplying the video signal with the inverted polarity to the data line.

The pixel cells adjacent along the gate-line direction are supplied with the video signals with the different polarities.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view illustrating a liquid crystal display device according to the related art;

FIG. 2 is a schematic view illustrating a liquid crystal display device according to a first embodiment of the present invention;

FIG. 3 is a waveform diagram illustrating a driving method of liquid crystal display device according to the first embodiment of the present invention;

FIG. 4 is a diagram illustrating a polarity pattern of video signal supplied to a display area in a driving method of liquid crystal display device according to the first embodiment of the present invention;

FIG. 5 is a waveform diagram illustrating a driving method of liquid crystal display device according to a second embodiment of the present invention; and

FIG. 6 is a diagram illustrating a polarity pattern of video signal supplied to a display area in a driving method of liquid crystal display device according to the second embodiment of the present invention.

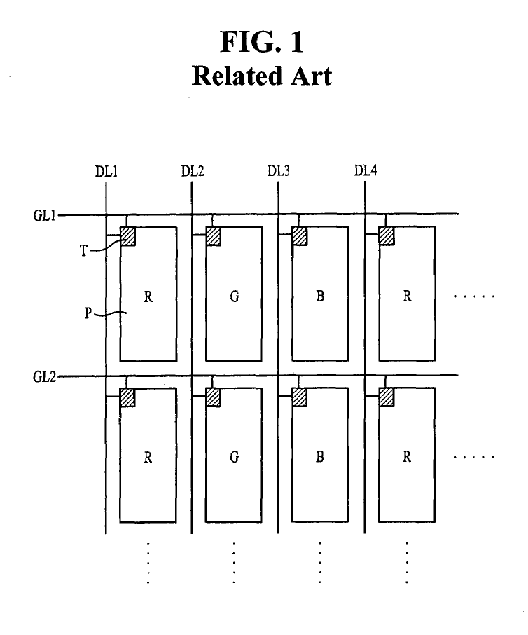

### DETAILED DESCRIPTION OF THE ILLUSTRATED EMBODIMENTS

Reference will now be made in detail to embodiments of the present invention, examples of which are illustrated in the accompanying drawings. Wherever possible, the same reference numbers will be used throughout the drawings to refer to the same or like parts.

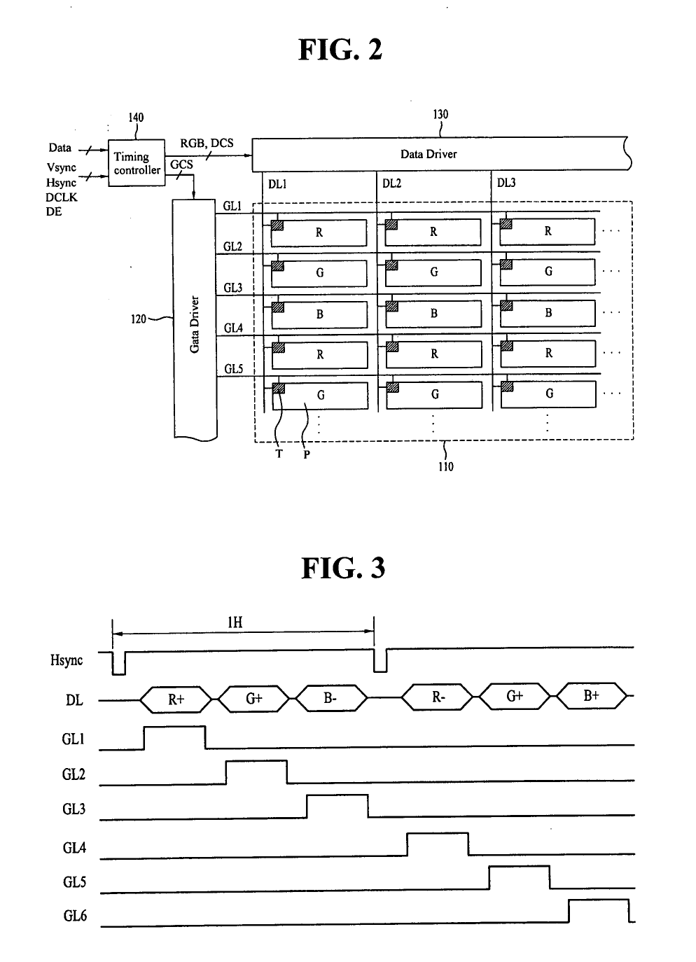

FIG. 2 is a schematic view illustrating a liquid crystal display device according to a first embodiment of the present invention.

Referring to FIG. 2, the liquid crystal display device according to the first embodiment of the present invention includes a display area 110, a gate driver 120, a data driver 130, and a timing controller 140. At this time, the display area 110 includes a plurality of pixel cells which are formed in respective regions defined by a plurality of gate lines GL and data lines DL, wherein the pixel cells arranged along a data-line direction (vertical direction) are provided with at least three colors repetitively arranged by turns, and the pixel cells arranged along a gate-line direction (horizontal direction) are provided with the same color. The gate driver 120 drives the gate lines GL in sequence, and the data driver 130 supplies video signals to the data lines DL. The timing controller 140 controls the gate and data drivers 120 and 130 such that the video signals of the different polarities are supplied to the pixel cells arranged along the data-line direction every 2N pixel cells (‘N’ is an integer).

The display area 110 includes the plurality of data lines DL arranged in parallel at fixed intervals; the plurality of gate lines GL formed in parallel at fixed intervals, wherein each gate line GL is orthogonal or substantially perpendicular to each data line DL; and the plurality of pixel cells formed in the respective regions defined by the plurality of data lines DL and gate lines GL.

When arranging the plurality of pixel cells, the red (R), green (G) and blue (B) pixel cells are repetitively arranged along the data-line DL direction, and the same-color pixel cells are arranged along the gate-line GL direction. In other words, the display area 110 is formed using a horizontal-stripe type pixel structure. A red (R), green (G) and blue (B) pixel cell together constitute one unit pixel to display one unit pixel of a color image.

Each of the pixel cells includes a thin film transistor T connected to the data line DL and the gate line GL, and a pixel P connected to the thin film transistor T. According as the thin film transistor T is turned-on by a gate signal supplied to the gate line GL, the video signal of data line DL is supplied to the pixel P.

The pixel P is includes a pixel electrode connected to a common electrode and the thin film transistor in state of interposing liquid crystal therebetween, whereby the pixel P may be equivalently represented as a liquid crystal capacitor. Also, a liquid crystal cell includes a storage capacitor to maintain the video signal charged into the liquid crystal capacitor until a next video signal is charged therein.

The plurality of pixel cells, including red(R), green(G), blue(B), and white(W) pixel cells may be repetitively arranged along the data-line DL direction, with same-color pixel cells may be arranged along the gate-line GL direction. Each of the red(R), green(G), and blue(B) pixel cells has the corresponding color filter, while the white(W) pixel cell has no color filter therein. For the purpose of discussion below, each unit pixel includes the red (R), green (G), and blue (B) pixel cells.

The timing controller 140 aligns source data Data supplied from the external to be suitable for driving the display area 110, and supplies the aligned source data to the data driver 130. In particular, to supply the video signal to the red(R), green(G) and blue(B) pixel cells during one horizontal period, the timing controller 140 time-divides one horizontal period into first, second, and third sub-periods. Accordingly, the timing controller 140 aligns the source data Data as signals for the first, second, and third sub-periods. Further, the timing controller 140 supplies the red (R) source data to the data driver 130 during the first sub-period, supplies the green (G) source data to the data driver 130 during the second sub-period, and supplies the blue (B) source data to the data driver 130 during the third sub-period.

The timing controller 140 generates a gate control signal GCS and a data control signal DCS by using at least one of a dot clock DCLK, a data enable signal DE, and vertically and horizontally synchronized signals Vsync and Hsync supplied from the external, wherein the gate control signal GCS and the data control signal DCS cause the corresponding video signal to be supplied to the respective pixel cells of the display area 110 during the first, second, and third sub-periods.

The gate control signal GCS for controlling a driving timing of the gate driver 120 includes a gate start pulse GSP, a gate shift clock GSC, and a gate output enable GOE. The data control signal DCS for controlling a driving timing of the data driver 130 includes a source output enable SOE, a source shift clock SSC, a source start pulse SSP, and a polarity control signal POL. In the illustrated embodiment, the timing controller 140 generates the polarity control signal POL which controls the inversion of the polarity of video signal along the data-line DL direction for every two pixel cells.

The gate driver 120 sequentially generates the gate signal in response to the gate control signal GCS from the timing controller 140, and sequentially supplies the gate signal to the gate lines GL. Accordingly, the gate lines GL included in the display area 110 are sequentially driven in response the gate signal from the gate driver 120. In the illustrated embodiment, the gate driver 120 is formed on a substrate including the display area 110 during the process of forming the thin film transistor, so that the gate driver 120 is connected to the gate line GL.

The data driver 130 converts a data signal RGB supplied from the timing controller 140 into an analog video signal according to the data control signal DCS from the timing controller 140, and supplies the analog video signal to the data lines DL. The data driver 130 inverts the polarity of video signal for every two pixel cells along the data-line DL direction in response the polarity control signal POL provided among the data control signals DCS, and inverts the polarity of video signal for each one pixel cell along the gate-line GL direction in response to the polarity control signal POL.

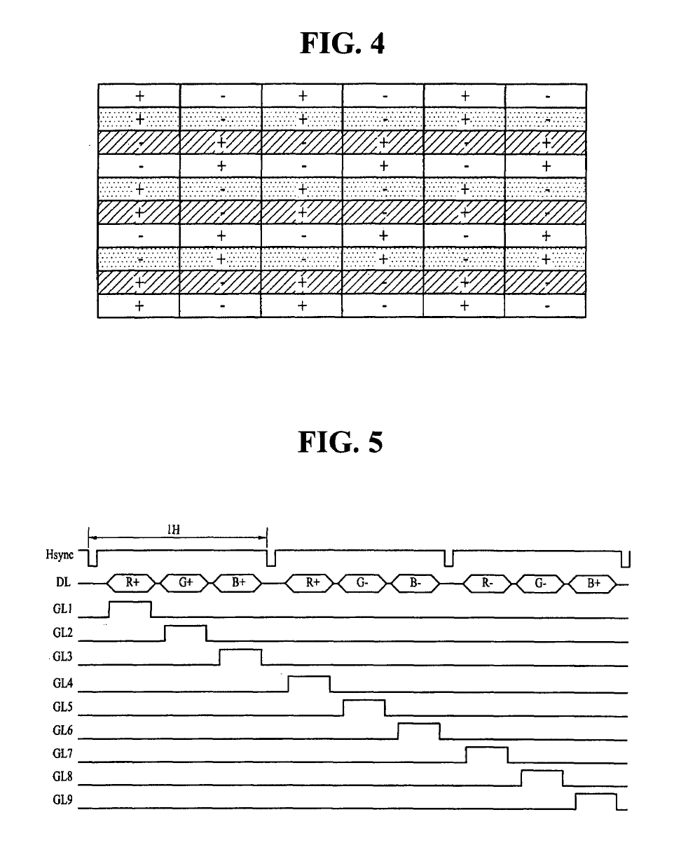

FIG. 3 is a waveform diagram illustrating a waveforms supplied when using a driving method of liquid crystal display device according to the first embodiment of the present invention. FIG. 4 is a diagram illustrating a polarity pattern of video signal supplied to a display area in a driving method of liquid crystal display device according to the first embodiment of the present invention.

Referring to FIGS. 3 and 4, the liquid crystal display device according to the first embodiment of the present invention and the method of driving the same will be explained as follows.

First, the gate signal is supplied to the first gate line GL1 during the first sub-period of the first horizontal period. In synchronization with the supply of gate signal to the first gate line GL1, the red video signal (R+) with positive (+) polarity is supplied to the data lines DL. Accordingly, the respective pixel cells of the first horizontal line are displayed as the red images corresponding to the red video signal (R+) with positive (+) polarity.

The gate signal is supplied to the second gate line GL2 during the second sub-period of the first horizontal period. In synchronization with the supply of gate signal to the second gate line GL2, the green video signal (G+) with positive (+) polarity is supplied to the data lines DL. Accordingly, the respective pixel cells of the second horizontal line are displayed as the green images corresponding to the green video signal (G+) with positive (+) polarity.

The gate signal is supplied to the third gate line GL3 during the third sub-period of the first horizontal period. In synchronization with the supply of gate signal to the third gate line GL3, the blue video signal (B−) with negative (−) polarity is supplied to the data lines DL. Accordingly, the respective pixel cells of the third horizontal line are displayed as the blue images corresponding to the blue video signal (B−) with negative (−) polarity.

During the first horizontal period, one unit pixel is displayed as the desired color image by temporal mixing of the red, green and blue images displayed in the respective first, second, and third sub-periods.

Thereafter, the gate signal is supplied to the fourth gate line GL4 during the first sub-period of the second horizontal period. In synchronization with the supply of gate signal to the fourth gate line GL4, the red video signal (R−) with negative (−) polarity is supplied to the data lines DL. Accordingly, the respective pixel cells of the fourth horizontal line are displayed as the red images corresponding to the red video signal (R−) with negative (−) polarity.

The gate signal is supplied to the fifth gate line GL5 during the second sub-period of the second horizontal period. In synchronization with the supply of gate signal to the fifth gate line GL5, the green video signal (G+) with positive (+) polarity is supplied to the data lines DL. Accordingly, the respective pixel cells of the fifth horizontal line are displayed as the green images corresponding to the green video signal (G+) with positive (+) polarity.

The gate signal is supplied to the sixth gate line GL6 during the third sub-period of the second horizontal period. In synchronization with the supply of gate signal to the sixth gate line GL6, the blue video signal (B+) with positive (+) polarity is supplied to the data lines DL. Accordingly, the respective pixel cells of the sixth horizontal line are displayed as the blue images corresponding to the blue video signal (B+) with positive (+) polarity.

In the second horizontal period, one unit pixel is displayed as the desired color image by temporally mixing the red, green and blue images displayed in the respective first, second, and third sub-periods.

After the second horizontal period, the pixel cells of each subsequent horizontal period are alternately supplied with the video signal in the same order and polarity pattern as those of the first and second horizontal periods.

The liquid crystal display device according to the first embodiment of the present invention and the method of driving the same includes the plurality of pixel cells, wherein the pixel cells arranged along the data-line direction are provided with at least three colors, and the pixel cells arranged along the gate-line direction are provided with the same color.

As a result, the number of data lines can be decreased to ⅓ of the related art, and the number of output channels included in the data driver 130 may also be decreased to ⅓ of the related art. While the number of gate lines is increased by a factor of three times compared to the liquid crystal display of the related art, the structure of gate driver 120 for drive the gate lines is relatively simple in comparison to the structure of data driver 130 to drive the data lines. As a result, the increased number of gate lines does not result in a large increase of fabrication cost of device. Further, if the process of forming the gate driver 120 and the process of forming the thin film transistor are performed on the substrate at the same time, the formation of the gate driver results in substantially no additional cost.

The liquid crystal display device according to the first embodiment of the present invention and the method of driving the same inverts the polarity of video signal every two pixel cells along the data-line DL direction. Among the plurality of unit pixels, each unit pixel includes the red (R), green (G) and blue (B) pixel cells. For adjacent unit pixels, the unit pixels differ in the timing of a polarity transition of video signal supplied to the unit pixel. Thus, it is possible to prevent some of the pixel cells from being relatively brighter or darker, to thereby prevent deterioration in resolution of picture image. For example, in the above-described embodiment, for the odd numbered horizontal periods, the polarity transition of video signal occurs in the first and third sub-periods, while for the even numbered horizontal periods, the transition of video signal occurs only in the second sub-period. Accordingly, the polarity transition of video signal is varied in each of the adjacent unit pixels, thereby preventing the deterioration of picture quality.

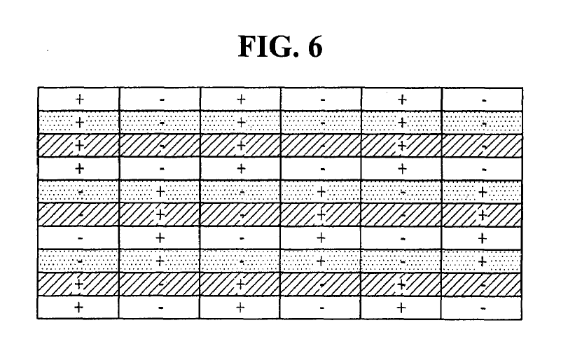

FIG. 5 is a waveform diagram illustrating a driving method of liquid crystal display device according to a second embodiment of the present invention. FIG. 6 is a diagram illustrating a polarity pattern of video signal supplied to a display area in a driving method of liquid crystal display device according to the second embodiment of the present invention.

With the exception of the polarity pattern of video signal supplied to the pixel cells along the data-line direction, the liquid crystal display device according to a second embodiment of the present invention and the method of driving the same shown in FIGS. 5 and 6 is identical to those of the first embodiment of the present invention discussed above with reference to FIGS. 3 and 4. That is, in case of the liquid crystal display device according to the second embodiment of the present invention, the polarity of video signal is inverted for every four pixel cells along the data-line direction, and the polarity of video signal is inverted for every one pixel cell along the gate-line direction by the polarity control signal POL.

Accordingly, the liquid crystal display device according to the second embodiment of the present invention and the method of driving the same have the same advantageous properties as those according to the first embodiment of the present invention.

In the liquid crystal display device according to the second embodiment of the present invention, the polarity of video signal may be inverted for every 2N pixel cells along the data-line DL direction according to the polarity control signal POL, and the polarity of video signal is inverted for every one pixel cell along the gate-line GL direction.

Furthermore, the liquid crystal display device according to the present invention can decrease the number of polarity transitions of video signal by inverting the polarity of video signal every 2N pixel cells along the data-line direction, to thereby decrease power consumption.

The liquid crystal display device according to the preset invention includes a plurality of pixel cells, wherein the pixel cells along the data-line direction included pixel cells of at least three colors repetitively arranged by turns, and wherein the pixel cells along the gate-line direction are provided with the same color. Thus, it is possible to decrease the number of data lines to ⅓ of the number of data lines used in the related art liquid crystal display device, and to decrease the number of output channels of the data driver to ⅓ of the number used in the related art liquid crystal display device, thereby decreasing the fabrication cost of device.

In addition, the polarity of video signal is inverted every 2N pixel cells along the data-line direction, and the polarity of video signal is inverted every one pixel cell along the gate-line direction. Accordingly, among the plurality of unit pixels, each unit pixel including the red(R), green(G) and blue(B) pixel cells, one unit pixel is different from the adjacent unit pixel in the position of the pixel cell in which a polarity transition of video signal occurs. Thus, it is possible to prevent some of the pixel cells from being relatively brighter or darker to thereby prevent deterioration in resolution of picture image.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display device comprising:
a display area including a plurality of pixel cells formed in respective regions defined by crossings of a plurality of gate lines with a plurality data lines, the pixel cells along a direction of each data line provided with at least three colors arranged by color in turns, and wherein the pixel cells along a direction of each gate line direction have a same color; and
a data driver that supplies video signals to the data lines,
wherein the data driver inverts the polarity of the video signals every 2Nth pixel cell along the data-line direction, where N is a positive integer.

2. The liquid crystal display device of claim 1, wherein the adjacent pixel cells of at least three colors along the direction of each data line constitute one unit pixel.

3. The liquid crystal display device of claim 1, further comprising:
a gate driver that sequentially drives the gate lines;
a timing controller that aligns source data supplied from a source external to the liquid crystal display device as data signals, that supplies data signals to the data driver, and that controls the gate and data drivers.

4. The liquid crystal display device of claim 3, wherein the timing controller time-divides one horizontal period into first, second, and third sub-periods; aligns the source data as the data signals for the first, second, and third sub-periods; supplies the data signals to the data driver; and generates a control signal including a polarity control signal to invert the polarity of the video signals every 2Nth pixel cells along the direction of each data line.

5. The liquid crystal display device of claim 4, wherein the data driver converts the data signals into the video signals; inverts the polarity of video signals in response to the polarity control signal; and supplies the video signal with the inverted polarity to the data lines.

6. The liquid crystal display device of claim 5, wherein the data driver supplies the video signals of different polarities to the adjacent pixel cells along the direction of each gate line.

7. A liquid crystal display device comprising:
a display area including a plurality of pixel cells formed in respective regions defined by the crossing of plurality of gate lines with a plurality of data lines, the pixel cells along a direction of each data line provided with at least three colors arranged by color in turns, and wherein the pixel cells along a direction of each gate line direction have a same color; and
a data driver that supplies a video signal to the pixel cells using the data lines; wherein the data driver inverts the polarity of the video signal in response to a polarity control signal,
wherein the adjacent pixel cells of at least three colors along the direction of each data line constitute one unit pixel, and
wherein each unit pixel differs from an adjacent unit pixel being adjacent along the data-line direction in the pixel cell of the unit cell at which a polarity transition of video signal occurs.

8. The liquid crystal display device of claim 7, further comprising:
a gate driver that drives the gate lines in sequence;
a timing controller to align source data supplied from the external as data signals, to supply the data signals to the data driver, and to control the gate and data drivers.

9. The liquid crystal display device of claim 8, wherein the timing controller time-divides one horizontal period into first, second, and third sub-periods; aligns the source data as the data signals for the first, second, and third sub-periods; supplies the aligned data signals to the data driver; and generates a control signal including the polarity control signal to invert the polarity of video signal every 2N pixel cells along the direction of each data line, where N is a positive integer.

10. The liquid crystal display device of claim 9, wherein the data driver converts the data signal into the video signal; inverts the polarity of the video signal in response to the polarity control signal; and supplies the video signal with the inverted polarity to the data lines.

11. The liquid crystal display device of claim 10, wherein the data driver supplies the video signals of the different polarities to the adjacent pixel cells along the direction of each gate line.

12. A driving method of liquid crystal display device comprising:
supplying video signals with the different polarities to pixel cells by inverting the polarity of video signal every 2Nth pixel cells along each of a plurality of data lines in a display area including a plurality of pixel cells formed in respective regions defined by crossings of a plurality of gate lines with the plurality of data lines, the pixel cells along the direction of each data line provided with at least three colors arranged by color in turns, and the pixel cells along a direction of each gate line having a same color, where N is a positive integer.

13. The driving method of claim 12, wherein the adjacent pixel cells of at least three colors along the direction of each data line constitute one unit pixel.

14. The driving method of claim 12, further comprising:
time-dividing one horizontal period into first, second, and third sub-periods;
aligning source data supplied from the external as data signals for the first, second, and third sub-periods; and
generating a control signal including a polarity control signal to invert the polarity of video signal every 2Nth pixel cells along the direction of each data line.

15. The driving method of claim 14, wherein supplying the video signal to the data lines comprises:
converting the data signal aligned for the respective sub-periods into the video signal;
inverting the polarity of video signal according to the polarity control signal; and
supplying the video signal with the inverted polarity to the data line.

16. The driving method of claim 15, wherein the pixel cells adjacent along the gate-line direction are supplied with the video signals with the different polarities.

17. A driving method of liquid crystal display device provided with a display area including a plurality of pixel cells formed in respective regions defined by the crossings of plurality of gate lines and a plurality of data lines, the pixel cells along a direction of each data line provided with at least three colors arranged by color in turns, and the pixel cells along the direction of each gate line having a same color, comprising:
supplying gate signals to the gate lines in sequence; and
supplying video signals to the data lines in synchronization with the gate signal,
wherein the adjacent pixel cells of at least three colors along the direction of each data line constitute one unit pixel, and
wherein each unit pixel is different an adjacent unit pixel along a direction of each data line direction in the pixel cell at which a polarity transition of video signal occurs.

18. The driving method of claim 17, further comprising:
time-dividing one horizontal period into first, second, and third sub-periods;
aligning source data supplied from the external as data signals for the first, second, and third sub-periods; and
generating a control signal including a polarity control signal to invert the polarity of video signal every 2N pixel cells along the direction of each data line, where N is a positive integer.

19. The driving method of claim 18, wherein supplying the video signal to the data lines comprises:
converting the data signal aligned for the respective sub-periods into the video signal;
inverting the polarity of video signal according to the polarity control signal; and
supplying the video signal with the inverted polarity to the data line.

20. The driving method of claim 19, wherein adjacent pixel cells along the direction of each gate line are supplied with the video signals having different polarities.
